(19) United States
(12) Patent Application Publication
(10) Pub. No.: US 2017/0253511 A1
(43) Pub. Date: Sep. 7, 2017

(54) SYSTEM AND METHOD FOR HOUSEHOLD WASTE WATER TREATMENT

(71) Applicants: Wojciech BABINSKI, Lomza (PL); Beata BABINSKA, Lomza (PL)

(72) Inventors: Wojciech BABINSKI, Lomza (PL); Beata BABINSKA, Lomza (PL)

(21) Appl. No.: 15/063,083

(22) Filed: Mar. 7, 2016

(51) Int. Cl. C02F 3/20; C02F 3/22; C02F 1/00; C02F 3/00; C02F 3/30

(52) U.S. Cl. CPC C02F 3/20; C02F 3/006; C02F 3/301; C02F 1/008; C02F 3/223; C02F 2103/002

(57) ABSTRACT

A waste water treatment system and method for use with a septic tank includes sequentially executing the steps of aerating waste water in the septic tank for a first period of time with an air diffuser, allowing the waste water to sediment for a second period of time, and pumping purified waste water out of the septic tank for a third period of time.

### FIELD

The present disclosure relates generally to a waste water treatment, and, more particularly, to system and method for effectively treating household waste water with aerobic bacteria.

### BACKGROUND

Conventionally, household waste water or sewage is treated with a septic tank before being released to ground. The septic tank is basically a large container buried in the ground near a house that collects and treats waste water. A first known system of this type in the United States was put into operation in 1876. Partitions in the septic tank, which improved the treatment effectiveness by regulating the flow of waste water, were added in 1905. At the turn of the twentieth century, the use of septic tanks became widespread. After the Second World War, it has become the primary system for waste water treatment in areas without sewer systems.

The septic tank treats waste water fundamentally through a sedimentation process which involves separation of relatively heavy solid phase material from liquid in the waste water over time and with the effect of gravity. The effectiveness of the sedimentation process is determined by the flow rate of inflow waste water as well as the lack of whirling in the waste water. Lower flow rate, suppression of flow energy, evenly distributing inlets and high water level in the sedimentation tank can enhance the effectiveness of the sedimentation process.

Another process occurring in the septic tank which leads to reduction in impurities in waste water is a floatation process. During the floatation process, air bubbles (gas) or buoyancy lifts hydrophobic suspensions, such as oils and fats, to the surface of the liquid, and form a layer of scum. Vegetative mold fungi may grow on the surface of the scum.

As a result of the aforementioned sedimentation process, residues are deposited at a bottom of the septic tank after long setting time and activities of bacteria undergoing anaerobic stabilization (psychrophilic fermentation) at 8-12° C.

In addition to the septic tank, a trickling drainage may be employed thereafter to further treat and evenly spread partially treated waste water over a large area of soil. Anaerobic bacteria, raw sewage and small particles can also accumulate in the trickling drainage. In order to maintain effectiveness of the trickling drainage, routinely, usually every three years, pumping out the residuals accumulated at a bottom of such trickling drainage is necessary. This adds cost and inconvenience for such anaerobic waste water treatment system. To overcome this problem, aerobic systems have been developed and in use throughout the United States for more than forty years.

As the name implies, aerobic systems utilizes aerobic bacteria to treat waste water in septic tanks. Such systems use air blower to introduce air into the septic tank. Aerobic systems have many advantages over anaerobic ones. Many aerobic systems are capable of producing clear and odorless discharges that are less likely to contaminate ground water and greatly prolong the life of a secondary treatment system. The effluent produced by such aerobic system is of high enough quality that some States allow these types of clear and odorless discharges to be released directly to the ground surface through open pipes or spray irrigation.

However, retrofitting an existing anaerobic septic tank into an effective aerobic one remains to be a challenge. For one thing, an existing septic tank often has an opening as small as twenty inches in diameter, which makes installing new equipment therein difficult.

As such, it is desirable to provide a system that can be installed through a small opening and a method that can improve waste water treatment efficiency.

### SUMMARY

Disclosed and claimed herein is a waste water treatment system and method for use with a septic tank, the system and method include sequentially executing the steps of aerating waste water in the septic tank for a first period of time with an air diffuser, allowing the waste water to sediment for a second period of time, and pumping purified waste water out of the septic tank for a third period of time.

Other aspects, features, and techniques will be apparent to one skilled in the relevant art in view of the following detailed description of the embodiments.

### BRIEF DESCRIPTION OF THE DRAWINGS

The drawings accompanying and forming part of this specification are included to depict certain aspects of the present disclosure. A clearer conception of the present disclosure, and of the components and operation of systems provided with the present disclosure, will become more readily apparent by referring to the exemplary, and therefore non-limiting, embodiments illustrated in the drawings, wherein like reference numbers (if they occur in more than one view) designate the same elements. The present disclosure may be better understood by reference to one or more of these drawings in combination with the description presented herein. It should be noted that the features illustrated in the drawings are not necessarily drawn to scale.

FIG. 1 schematically illustrates a waste water treatment system according to an embodiment of the present disclosure.

FIG. 2 is a flowchart illustrating a waste water treatment method according to an embodiment of the present disclosure.

### DESCRIPTION

One aspect of the disclosure relates to transforming an existing anaerobic septic tank into aerobic one, and to implementing a novel sequential waste water treatment method. Embodiments of the present disclosure will be described hereinafter with reference to the attached drawings.

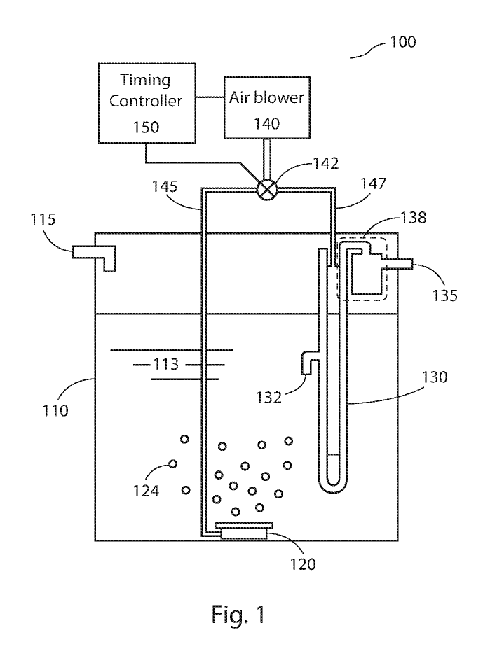

FIG. 1 schematically illustrates a waste water treatment system 100 according to an embodiment of the present disclosure. The waste water treatment system 100 includes a septic tank 110, an air diffuser 120, an airlift pump (Mammoth pump) 130, an air blower 140 and a timing controller 150. In one embodiment, the septic tank 110 may be a pre-existing one buried in the ground near a house and originally built to operate primarily on anaerobic bacteria. The pre-existing septic tank 110 has one or more a small openings (not shown)—often less than 12 inches in diameter, on the top. The air diffuser 120 and the airlift pump 130 of the present disclosure can be installed in the septic tank 110 through these openings. In other embodiments, the septic tank 110 may be a newly built one including the same feature elements as described above.

Referring again to FIG. 1, the septic tank 110 has an inlet 115 near a top thereof for household waste water 113 to flow into the septic tank 110. The air diffuser 120 is weighted, of either a plate type or a pipe type, and placed at a bottom of the septic tank 110 for dispersing air bubbles 124 into the waste water 113. Ideally, the air diffuser 120 is placed at the bottom and near a center of the septic tank 110. For a good result, the air diffuser 120 should be located no more than thirty five percent of the distance from the center of the septic tank 110, and no more than four inches above the bottom of the septic tank 110. It is also desirable for the diffuser 120 to cover a large area. However, the size of the air diffuser 120 is limited by the size of openings of a pre-existing septic tank 110. In embodiments, more than one air diffusers can be installed in the septic tank 110.

Referring again to FIG. 1, air is blown to the air diffuser 120 by the air blower 140 through a valve 142 and a hose 145 under the control of the timing controller 150. In one embodiment, the air blower 140 and the valve 142 are conveniently placed outside of the septic tank 110, and the hose 145 is of a flexible type and one half inch in diameter.

Referring again to FIG. 1, the airlift pump 130 has an inlet 132 below a waste water surface, and an outlet 135 leads to outside of the septic tank 110. The airlift pump 130 is placed in such a way that a bottom part of the airlift pump 130 is located not less than four inches from the bottom of the septic tank 110, and a top part of the airlift pump 130 is not less than four inches above the level of the outlet 135. The top part of the airlift pump 130 include a deflector 138 which functions as an air barrier designed to not allow untreated waste water to escape the septic tank 110 through the outlet 135. In addition, a height of the inlet 132 of the airlift pump 130 is also important, which can be determined based on a level of the waste water 113 so that only purified waste water without uncleaned particles is picked up by the airlift pump 130. In one embodiment, the inlet 132 is located at a height equal to approximately two third of a distance from the bottom of the septic tank 110 to the outlet 135.

Although FIG. 1 shows only one airlift pump 130 is installed in the septic tank 110, in case of large discharge volume, multiple airlift pumps can be installed in the same septic tank 110. With the effectiveness of the presently disclosed waste water treatment system 100, effluent from the outlet 135 can generally be directly discharged to surrounding ground. However, the outlet 135 can also be connected to a secondary treatment system (not shown) such as a trickling drainage before releasing treated waste water to the ground.

As shown in FIG. 1, the airlift pump 130 receives air also from the air blower 140 though the valve 142 and a hose 147 which is, for instance, one half inch in diameter. The valve 142 functions to direct air flow to either the hose 145 or the hose 147, or stop the air flow altogether. Although, as shown in FIG. 1, the air blower 140 in combination with the valve 142 is exemplarily used for supplying air to either the air diffuser 120 or the airlift pump 130, two separately controlled air blowers can be used to individually supply air to the air diffuser 120 and the airlift pump 130.

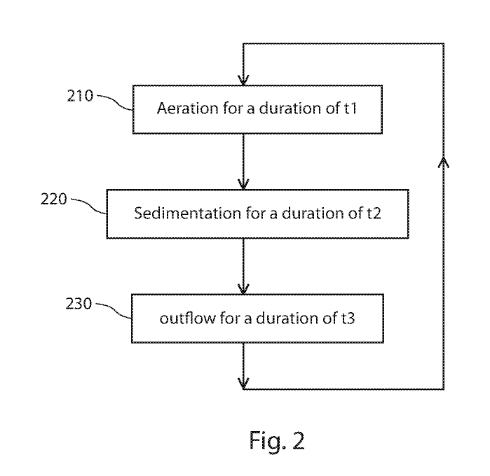

According to embodiments of the present disclosure, the timing controller 150 controls the waste water treatment system 100 to perform aeration, sedimentation and outflow operations sequentially as depicted in FIG. 2. The timing controller 150 may be implemented with a timer equipped state machine or by a computer.

FIG. 2 is a flowchart illustrating a waste water treatment method according to an embodiment of the present disclosure, which sequentially circulating among three processing steps: aeration step 210, sedimentation step 220 and outflow step 230. During the aeration step 210, the air blower 140 is turned on and the valve 142 is switched to a position to allow air to flow only to the air diffuser 120. Introducing air into the septic tank 110 produces an activated sludge in the septic tank 110. The activated sludge forms a living suspension of heterotrophic bacteria and protozoa in the waste water 113. The living suspension carries out oxidation of organic compounds that causes nitrification and denitrification of the substance in the waste water 113. During the aeration step 210, bio-sorption and reduction of selected pollutants by microorganisms may also occur. Duration (t1) of the aeration step 210 is predetermined and stored in and executed by the timing controller 150. Alternatively, the duration t1 can be dynamically adjusted by the timing controller based on conditions of the waste water 113, which can be measured by sensors installed in the septic tank 110. In one embodiment, the duration t1 is set at between 5 to 30 minutes.

During the sedimentation step 220 which is subsequent to the aeration step 210, the air blower 140 is shut off, so that aeration of the waste water 113 is substantially stopped. During this period, sludge in the waste water 113 is allowed to settle onto the bottom, and purified waste water in the form of resembling water floats to the top of the septic tank 110. Duration (t2) of the sedimentation step 220 can also be predetermined and stored in and executed by the timing controller 150. In one embodiment, the duration t2 is set at 90 minutes. In an embodiment, the duration t2 should not be less than 60 minutes or exceed 120 minutes. In an alternative embodiment, a sensor may be placed in the septic tank 110 that measures the cleanliness of the purified waste water from time to time, and sends the cleanliness information to the timing controller 150 for determining the sedimentation duration (t2).

During the outflow step 230 which is subsequent to the sedimentation step 220, the air blower 140 is turned on and the valve 142 is switched to a position to allow air to flow only to the airlift pump 130 through the hose 147. As a result, purified waste water is pumped out of the septic tank 110 by the airlift pump 130 through the outlet 135. Duration (t3) of the outflow step 230 can be predetermined as well and stored in and executed by the timing controller 150. In one embodiment the duration t3 is set at 10 minutes. Alternatively, a sensor may be used to detect the level of the purified waste water in the septic tank 110, and sends the level information to the timing controller 150 for determining the start and stop of the outflow step 230.

As shown in FIG. 2, once the outflow step 230 is finished, the waste water treatment method completes a full cycle and can go back to the aeration step 210 to start a new cycle. Preferably, during a twenty four hour period, at least three such full cycles are run, but the number of such full cycles should not exceed six.

While this disclosure has been particularly shown and described with references to exemplary embodiments thereof, it shall be understood by those skilled in the art that various changes in form and details may be made therein without departing from the spirit of the claimed embodiments.

What is claimed is:

1. A waste water treatment method for use with a septic tank, the method comprising sequentially executing the steps of:
aerating waste water in the septic tank for a first period of time with an air diffuser;
allowing the waste water to sediment for a second period of time; and
pumping purified waste water out of the septic tank for a third period of time.

2. The method of claim 1, wherein the air diffuser is placed near a center of a bottom of the septic tank.

3. The method of claim 1, wherein the aerating includes forcing air to the air diffuser by an air blower placed outside of the septic tank through a flexible hose.

4. The method of claim 1, wherein the pumping is performed by an airlift pump placed in the septic tank, the airlift pump having an inlet positioned in the waste water and an outlet lead to outside of the septic tank.

5. The method of claim 4, wherein the airlift pump includes an air barrier to prevent waste water to overflow through the outlet.

6. The method of claim 4, wherein the inlet of the airlift pump is positioned at a height equal to approximately two third of a distance from a bottom of the septic tank to the outlet of the airlift pump.

7. The method of claim 4, wherein air is supplied to the airlift pump from an air blower placed outside the septic tank.

8. The method of claim 1, wherein the first, second and third period of time are predetermined, stored and executed by a timing controller.

9. The method of claim 1, wherein at least one of the first, second and third period of time is dynamically determined based on conditions of the waste water in the septic tank.

10. The method of claim 9, wherein the conditions of the waste water is detected by sensors placed in the septic tank.

11. A waste water treatment system comprising:
an air diffuser for being placed at a bottom of a septic tank;
an airlift pump for being placed in the septic tank with an inlet submerged in waste water contained in the septic tank and an outlet lead to outside of the septic tank;
one or more air blowers for supplying air to the air diffuser and the airlift pump; and
a timing controller configured to control the one or more air blowers to only supply air to the air diffuser for a first period of time followed by a second period of time of no air supply to either the air diffuser or the airlift pump and then only supply air to the airlift pump for a third period of time.

12. The waste water treatment system of claim 11, wherein the air supply from the air blower to the air diffuser is conducted through a flexible hose.

13. The waste water treatment system of claim 11, wherein the air diffuser is of a weighted plate type.

14. The waste water treatment system of claim 11, wherein the airlift pump includes an air barrier to prevent waste water to overflow through the outlet.

15. The waste water treatment system of claim 11, wherein the inlet of the airlift pump is positioned at a height equal to approximately two third of a distance from a bottom of the septic tank to the outlet of the airlift pump.

16. The waste water treatment system of claim 11 further comprising a valve for directing air flow to either the air diffuser or the airlift pump, the valve being controlled by the timing controller.

17. The waste water treatment system of claim 11, wherein the first, second and third period of time are predetermined, stored and executed by the timing controller.

18. The waste water treatment system of claim 11, wherein at least one of the first, second and third period of time is dynamically determined based on conditions of the waste water.

19. The waste water treatment system of claim 18 further comprising sensors placed in the septic tank for detecting the conditions of the waste water.

20. The waste water treatment system of claim 11, wherein the septic tank is buried in the ground employing anaerobic bacteria for treatment before installing the air diffuser.
